(19) United States
(12) Patent Application Publication
(10) Pub. No.: US 2007/0239590 A1
(43) Pub. Date: Oct. 11, 2007

(54) Two-step method and system for commodity trading

(76) Inventors: Gang Pil Lee, Los Angeles, CA (US); Eunice Eunjung Lee, Los Angeles, CA (US)

Correspondence Address: PARK LAW FIRM, 3255 WILSHIRE BLVD, SUITE 1110, LOS ANGELES, CA, 90010, US

(21) Appl. No.: 11/400,118

(22) Filed: Apr. 7, 2006

(51) Int. Cl. G06Q 40/00

(52) U.S. Cl. 705/37

(57) ABSTRACT

A commodity trading method and system are provided. A transaction consider point, a transaction positive point and a transaction negative point are determined by referring to the relation of a buying prediction line and a selling prediction line in a trading window, an entry window and an exit window, respectively. The windows show a buying prediction line and a selling prediction line with different time intervals. The time interval for a trading window is longer than the time interval for the entry window, and the time interval for the exit window is between the two other intervals. The buying prediction line is adapted to display the tendency of buyers according to a buying formulation that incorporates predetermined formulation factors. The selling prediction line is adapted to display the tendency of sellers according to a selling formulation that incorporates the predetermined formulation factors.

### BACKGROUND OF THE INVENTION

The present invention relates to a commodity trading system and method. More particularly, this invention relates to a commodity trading system and method that provides investment information for buying and selling commodities including foreign currency in two-step in order to help an investor's understanding and decision in trading commodities.

Exchanging foreign currency is a very large but unique market for investment. Features of foreign currency exchange market include large trading volume, extreme liquidity or volatility, large number of and various traders, worldwide distribution of traders, 24 hours trading time, and variety of factors affecting exchange rates. In the past, the uncertainty and variety of factors affecting foreign currency exchange market and government regulations limited the main participants as large banks, central banks, multinational corporations and other big and established financial institutions. Recently, share of retail traders, that is, small investors or speculators has been increasing, and foreign currency exchange became a viable target for investment by the general public.

The main differences between the foreign currency exchange market and other commodity exchange market such as stock market are that the objects for investment are simple, there are generally only several major currency pairs; there are huge number of participants worldwide; and profit and the risk of loss are large compared to the invested money (100 times of the invested money).

Many methods and systems have been developed to assist investor's understanding of the trend and status of the foreign currency exchange market and decision to buy or sell. However, it was practically impossible for the public to use the methods or systems, since they were developed for experts and were too difficult to understand and use.

A user-friendly method or system that is adapted for use by and training the general public has long been in need.

### SUMMARY OF THE INVENTION

The present invention contrives to solve the disadvantages of the prior art.

An objective of the invention is to provide a system and method for displaying commodity exchange information in a user-friendly format.

Another objective of the invention is to provide a system and method for displaying two opposing trading powers of buyers and sellers at different time intervals simultaneously.

Still another objective of the invention is to provide a system and method that displays the trading powers of buyers and sellers by strategic formulations that reflect various factors that lead the commodity exchange market.

Still another objective of the invention is to provide a system and method for commodity exchange that may be used to train investors.

In order to achieve the above objectives, the present invention provides a commodity trading system that includes a trading window that shows a buying prediction line and a selling prediction line with a first time interval, an entry window that shows the buying prediction line and the selling prediction line with a second time interval, and an exit window that shows the buying prediction line and the selling prediction line with a third time interval.

The first time interval is longer than the second time interval and the third time interval is longer than the second time interval and shorter than the first time interval and closer to the second time interval.

The buying prediction line is adapted to display the tendency of buyers according to a buying formulation that incorporates predetermined formulation factors.

The selling prediction line is adapted to display the tendency of sellers according to a selling formulation that incorporates the predetermined formulation factors.

The buying prediction line, and selling prediction line represent the buying power and the selling power of the participants of the commodity trading market, and are calculated by strategic formulation of the predetermined formulation factors.

A transaction consider point is determined by referring to the relation of the buying prediction line and the selling prediction line in the trading window.

A transaction positive point is determined by referring to the relation of the buying prediction line and the selling prediction line in the entry window after the transaction consider point.

A transaction negative point is determined by referring to the relation of the buying prediction line and the selling prediction line in the exit window after the transaction consider point.

The predetermined formulation factors include tick, high, low, bid, ask, volume, open and close.

At least part of the formulation factors are provided via a public communication network.

Preferably, the public communication network is the Internet.

The transaction consider point is determined as the time point when the buying prediction line and the selling prediction line in the trading window begin to diverge from each other after crossing, and the buying prediction line and the selling prediction line are increasing. Specifically the transaction consider point is determined as the time point when the first derivative of the buying prediction line or the selling prediction line is positive and the second derivative of the buying prediction line or the selling prediction line is positive.

The transaction positive point is determined as the time point that the buying prediction line or the selling prediction line in the entry window begin to show increasing tendency. Specifically, the transaction positive point is determined as the time point when the first derivative of the buying prediction line or the selling prediction line is around zero and the second derivative of the buying prediction line or the selling prediction line is positive in the entry window.

Alternatively, the transaction positive point is determined as the time point when the buying prediction line and the selling prediction line in the entry window begin to diverge from each other after crossing, and the buying prediction line and the selling prediction line are increasing. Specifically, the transaction positive point is determined as the time point when the first derivative of the buying prediction line or the selling prediction line is positive and the second derivative of the buying prediction line or the selling prediction line is positive.

The transaction negative point is determined as the time point when the buying prediction line or the selling prediction line in the exit window begins to show opposite tendency greater than a predetermined threshold. Specifically, the transaction negative point is determined as the time point when the second derivative of the buying prediction line or the selling prediction line is negative in the exit window.

An alert is issued when the transaction consider point, the transaction positive point or the transaction negative point is detected.

An alert is also issued when the transaction positive point is detected and the transaction negative point is not detected at a given moment.

The first time interval, the second time interval and the third time interval can be adjusted.

The lengths of the first time interval, the second time interval and the third time interval are given as common multiples.

Preferably, the ratio between the first time interval, the second time interval and the third time interval is in a range of 1: from about ⅙ to about 1/12: and from about ⅙ to about ⅓.

The present invention also provides a commodity trading method including the steps of determining a transaction consider point by referring to the relation of a buying prediction line and a selling prediction line in a trading window that shows a buying prediction line and a selling prediction line with a first time interval, determining a transaction positive point by referring to the relation of the buying prediction line and the selling prediction line after the transaction consider point in an entry window that shows the buying prediction line and the selling prediction line with a second time interval and determining a transaction negative point by referring to the relation of the buying prediction line and the selling prediction line after the transaction positive point in an exit window that shows the buying prediction line and the selling prediction line with a third time interval. The first time interval is longer than the second time interval and the third time interval is longer than the second time interval and shorter than the first time interval. The buying prediction line is adapted to display the tendency of buyers according to a buying formulation that incorporates predetermined formulation factors. The selling prediction line is adapted to display the tendency of sellers according to a selling formulation that incorporates the predetermined formulation factors.

The advantages of the present invention are: (1) the system and method provide the current trend of worldwide buyers and sellers in real time; (2) the system and method display the most recent trend of the commodity exchange market in combinations of different time intervals that facilitate prediction of the market; and (3) the system and method provide useful tool for simulation and training of commodity exchange for users.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a schematic diagram showing a foreign currency exchange system according to the present invention;

FIG. 2 is a screen shot of the foreign currency exchange system; and

FIG. 3 is a flow diagram showing a foreign currency exchange method according to the present invention.

### DETAILED DESCRIPTION OF THE INVENTION

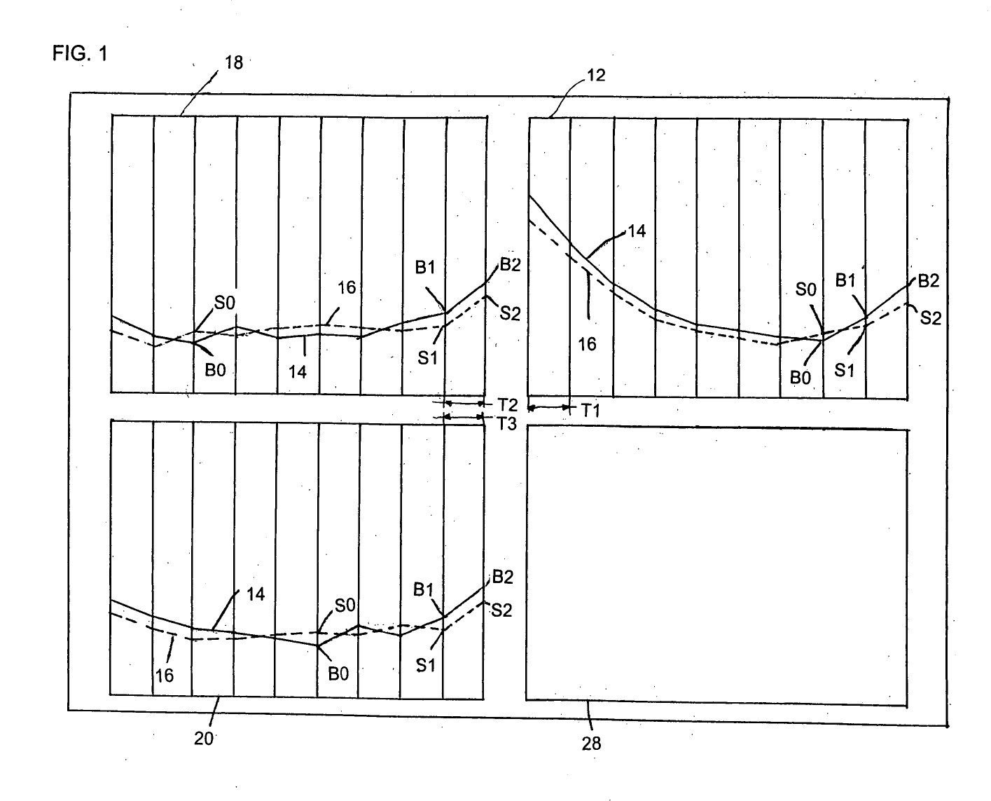

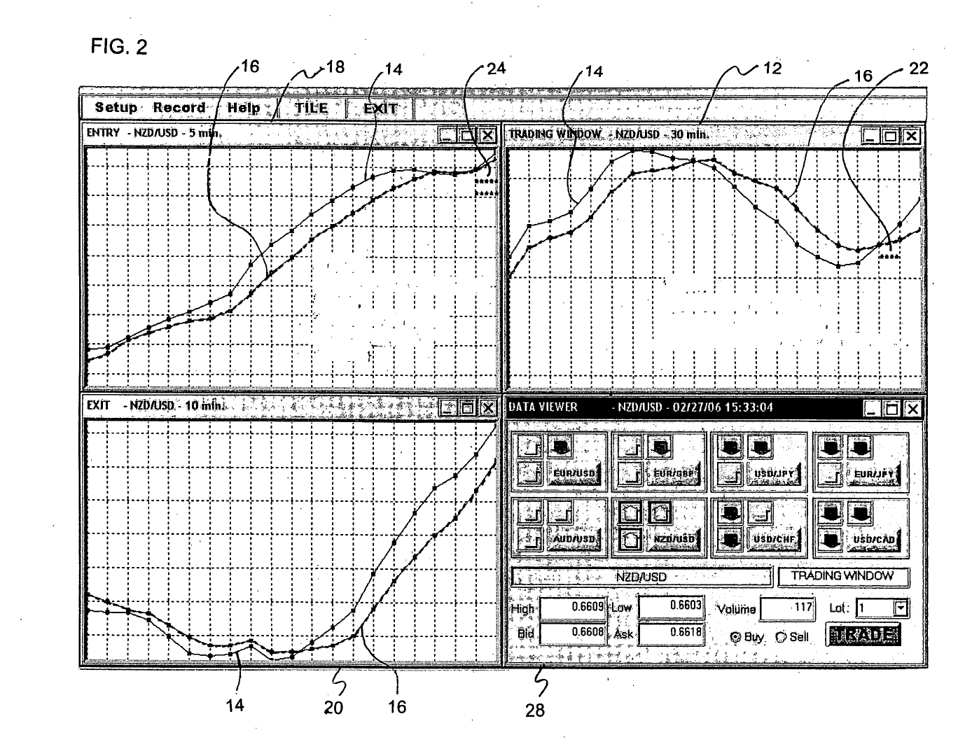

FIG. 1 shows a commodity trading system 10 according to the present invention. The commodity traded is foreign currency in this embodiment. The system 10 includes a trading window 12 that shows a buying prediction line 14 and a selling prediction line 16 with a first time interval T1, an entry window 18 that shows the buying prediction line 14 and the selling prediction line 16 with a second time interval T2, an exit window 20 that shows the buying prediction line 14 and the selling prediction line 16 with a third time interval T3, and a data viewer 28 that shows parameters related to foreign currency trading transactions (refer to FIG. 2).

The first time interval T1 is longer than the second time interval T2 (T2<T1). The third time interval T3 is longer than the second time interval T2 and shorter than the first time interval T1 (T2<T3<T1) and closer to the second time interval T2.

The buying prediction line 14 is adapted to display the tendency of buyers according to a buying formulation that incorporates predetermined formulation factors.

The selling prediction line 16 is adapted to display the tendency of sellers according to a selling formulation that incorporates the predetermined formulation factors.

FIG. 2 shows a screen shot of the commodity trading system 10. In the example shown in FIGS. 1 and 2, the first time interval T1, that is, one grid in the trading window 12, is 30 minutes, the second time interval T2, that is, one grid in the entry window 18 is 5 minutes, and the third time interval T3, that is, one grid in the exit window 20, is 10 minutes.

FIG. 1 diagrammatically shows the operation of the commodity trading system 10. Point B0 is the value of the buying prediction line 14 at a starting time point, and point S0 is the value of the selling prediction line 16 at the starting time point. Point B1 is the value of the buying prediction line 14 after time corresponding one grid of the trading window 12 is elapsed, that is, 30 minutes. Point S1 is the value of the selling prediction line 16 after 30 minutes from the starting time point. Point B2 is the current value of the buying prediction line 14. Point S2 is the current value of the selling prediction line 16. The right end of the windows 12, 18, 20 correspond to the current time point, and points B2, S2 are always displayed on the right end of the windows 12, 18, 20. In FIG. 1, the current time is some time after the time point that corresponds to points B1 and S1, and within one grid of the entry window 18, that is, 5 minutes.

Between the points B0 and B1, and S0 and S1, the buying prediction line 14 and the selling prediction line 16 are displayed over one grid in the trading window 12, over 6 grids in the entry window 18, and over 3 grids in the exit window 20, respectively.

The lines 14, 16 in the trading window 12 show the longest period among the three windows, and are suitable to predict general trend of the foreign currency trading market.

The lines 14, 16 in the entry window 18 show the most detailed trend for the time period that is immediately before the current time point, and are suitable to predict that the profit from the foreign currency transaction will increase.

The lines 14, 16 in the exit window 20 show more general trend than the lines in the entry window 18 and more detailed trend than the lines in the trading window 12, and are suitable to early predict that the loss from the foreign currency transaction will increase.

The first time interval T1, the second time interval T2 and the third time interval T3 can be adjusted.

Preferably, the lengths of the first time interval T1, the second time interval T2 and the third time interval T3 are given as common multiples.

Preferably, the ratio between the first time interval T1, the second time interval T2 and the third time interval is T3 in a range of 1: from about ⅙ to about 1/12: and from about ⅙ to about ⅓.

A transaction consider point 22 is determined by referring to the relation of the buying prediction line 14 and the selling prediction line 16 in the trading window 12.

A transaction positive point 24 is determined by referring to the relation of the buying prediction line 14 and the selling prediction line 16 in the entry window 18 after the transaction consider point 22.

A transaction negative point 26 is determined by referring to the relation of the buying prediction line 14 and the selling prediction line 16 in the exit window 20 after the transaction consider point 22.

The predetermined formulation factors include tick, high, low, bid, ask, volume, open and close.

At least part of the formulation factors are provided via a public communication network.

Preferably, the public communication network is the Internet, and the commodity exchange is foreign currency.

The transaction consider point 22 is determined as the time point when the buying prediction line 14 and the selling prediction line 16 in the trading window 12 begin to diverge from each other after crossing, and the buying prediction line 14 and the selling prediction line 16 are increasing. Specifically, the transaction consider point 22 is determined as the time point when the first derivative of the buying prediction line 14 or the selling prediction line 16 is positive and the second derivative of the buying prediction line 14 or the selling prediction line 16 is positive.

The transaction positive point 24 is determined as the time point that the buying prediction line 14 or the selling prediction line 16 in the entry window 18 begin to show increasing tendency. Specifically, the transaction positive point 24 is determined as the time point when the first derivative of the buying prediction line 14 or the selling prediction line 16 is around zero, and the second derivative of the buying prediction line 14 or the selling prediction line 16 is positive in the entry window 18.

Alternatively, the transaction positive point 24 is determined as the time point when the buying prediction line 14 and the selling prediction line 16 in the entry window 18 begin to diverge from each other after crossing, and the buying prediction line 14 and the selling prediction line 16 are increasing. Specifically, the transaction positive point is determined as the time point when the first derivative of the buying prediction line 14 or the selling prediction line 16 is positive and the second derivative of the buying prediction line 14 or the selling prediction line 16 is positive.

The transaction negative point 26 is determined as the time point when the buying prediction line 14 or the selling prediction line 16 in the exit window 20 begins to show opposite tendency greater than a predetermined threshold. Specifically, the transaction negative point 26 is determined as the time point when the second derivative of the buying prediction line 14 or the selling prediction line 16 is negative in the exit window 20.

An alert is issued when the transaction consider point 22, the transaction positive point 24 or the transaction negative point 26 is detected.

An alert is also issued when the transaction positive point 24 is detected and the transaction negative point 26 is not detected at a given moment. The user can decide trade when this alert is given. When this alert is not issued either the transaction positive point 24 is not detected or the transaction negative point 26 is detected, thereby indicating that there might exist a condition that is negative for taking profit from trading the foreign currency.

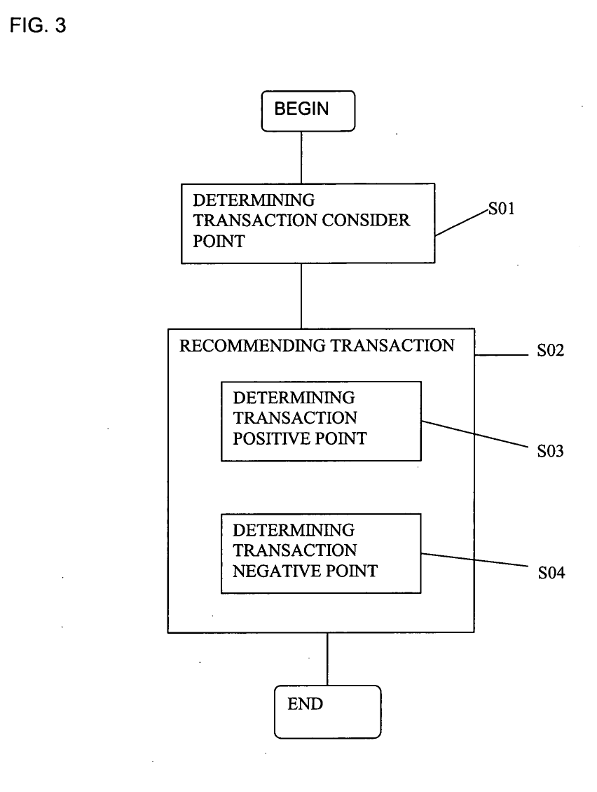

FIG. 3 shows a foreign currency trading method according to the invention. The foreign currency trading method utilizes the foreign currency trading system 10. The method includes step S01 of determining the transaction consider point 22 by referring to the relation of the buying prediction line 14 and the selling prediction line 16 in the trading window 12 and step S02 of recommending transaction. Step S02 includes step S03 of determining the transaction positive point 24 by referring to the relation of the buying prediction line 14 and the selling prediction line 16 after the transaction consider point 22 in the entry window 18 and step S04 of determining the transaction negative point 26 by referring to the relation of the buying prediction line 14 and the selling prediction line 16 after the transaction positive point 24 in the exit window 20. When the transaction positive point 24 is detected and the transaction negative point 26 is not detected at a given moment, an alert is issued for recommending transaction.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A commodity trading system comprising:
a) a trading window that shows a buying prediction line and a selling prediction line with a first time interval;
b) an entry window that shows the buying prediction line and the selling prediction line with a second time interval; and
c) an exit window that shows the buying prediction line and the selling prediction line with a third time interval;
wherein the first time interval is longer than the second time interval and the third time interval is longer than the second time interval and shorter than the first time interval and closer to the second time interval;
wherein the buying prediction line is adapted to display the tendency of buyers according to a buying formulation that incorporates predetermined formulation factors;
wherein the selling prediction line is adapted to display the tendency of sellers according to a selling formulation that incorporates the predetermined formulation factors;
wherein a transaction consider point is determined by referring to the relation of the buying prediction line and the selling prediction line in the trading window;
wherein a transaction positive point is determined by referring to the relation of the buying prediction line and the selling prediction line in the entry window after the transaction consider point.

2. The system of claim 1, wherein the predetermined formulation factors include tick, high, low, bid, ask, volume, open and close.

3. The system of claim 2, wherein at least part of the formulation factors are provided via a public communication network.

4. The system of claim 3, wherein the public communication network is the Internet.

5. The system of claim 1, wherein the transaction consider point is determined as the time point when the buying prediction line and the selling prediction line in the trading window begin to diverge from each other after crossing, and the buying prediction line and the selling prediction line are increasing.

6. The system of claim 5, wherein the transaction consider point is determined as the time point when the first derivative of the buying prediction line is positive and the second derivative of the buying prediction line is positive.

7. The system of claim 5, wherein the transaction consider point is determined as the time point when the first derivative of the selling prediction line is positive and the second derivative of the selling prediction line is positive.

8. The system of claim 5, wherein the transaction positive point is determined as the time point that the buying prediction line or the selling prediction line in the entry window begin to show increasing tendency.

9. The system of claim 8, wherein the transaction positive point is determined as the time point when the first derivative of the buying prediction line is around zero and the second derivative of the buying prediction line is positive in the entry window.

10. The system of claim 8, wherein the transaction positive point is determined as the time point when the first derivative of the selling prediction line is around zero and the second derivative of the selling prediction line is positive in the entry window.

11. The system of claim 8, wherein the transaction positive point is determined as the time point when the buying prediction line and the selling prediction line in the entry window begin to diverge from each other after crossing, and the buying prediction line and the selling prediction line are increasing.

12. The system of claim 11, wherein the transaction positive point is determined as the time point when the first derivative of the buying prediction line is positive and the second derivative of the buying prediction line is positive.

13. The system of claim 11, wherein the transaction positive point is determined as the time point when the first derivative of the selling prediction line is positive, and the second derivative of the selling prediction line is positive.

14. The system of claim 1, wherein a transaction negative point is determined by referring to the relation of the buying prediction line and the selling prediction line in the exit window after the transaction consider point.

15. The system of claim 14, wherein the transaction negative point is determined as the time point when the buying prediction line or the selling prediction line in the exit window begin to show opposite tendency greater than a predetermined threshold.

16. The system of claim 15, wherein the transaction negative point is determined as the time point when the second derivative of the buying prediction line is negative in the exit window.

17. The system of claim 15, wherein the transaction negative point is determined as the time point when the second derivative of the selling prediction line is negative in the exit window.

18. The system of claim 15, wherein an alert is issued when the transaction consider point, the transaction positive point or the transaction negative point is detected.

19. The system of claim 15, wherein an alert is issued when the transaction positive point is detected and the transaction negative point is not detected at a given moment.

20. The system of claim 1, wherein the first time interval, the second time interval and the third time interval can be adjusted.

21. The system of claim 20, wherein the lengths of the first time interval, the second time interval and the third time interval are given as common multiples.

22. The system of claim 21, wherein the ratio between the first time interval, the second time interval and the third time interval is in a range of 1: from about ⅙ to about 1/12: and from about ⅙ to about ⅓.

23. A commodity trading method comprising the steps of:
a) determining a transaction consider point by referring to the relation of a buying prediction line and a selling prediction line in a trading window that shows a buying prediction line and a selling prediction line with a first time interval; and
b) recommending transaction;
wherein the step of recommending transaction comprises:
i) determining a transaction positive point by referring to the relation of the buying prediction line and the selling prediction line after the transaction consider point in an entry window that shows the buying prediction line and the selling prediction line with a second time interval;
wherein the first time interval is longer than the second time interval;
wherein the buying prediction line is adapted to display the tendency of buyers according to a buying formulation that incorporates predetermined formulation factors;
wherein the selling prediction line is adapted to display the tendency of sellers according to a selling formulation that incorporates the predetermined formulation factors.

24. The method of claim 23, wherein the predetermined formulation factors include tick, high, low, bid, ask, volume, open and close.

25. The method of claim 23, wherein the transaction consider point is determined as the time point when the buying prediction line and the selling prediction line in the trading window begin to diverge from each other after crossing, and the buying prediction line and the selling prediction line are increasing.

26. The method of claim 25, wherein the transaction positive point is determined as the time point that the buying prediction line or the selling prediction line in the entry window begin to show increasing tendency.

27. The method of claim 23, wherein the step of recommending transaction further comprises:
determining a transaction negative point by referring to the relation of the buying prediction line and the selling prediction line after the transaction consider point in an exit window that shows the buying prediction line and the selling prediction line with a third time interval, wherein the third time interval is longer than the second time interval and shorter than the first time interval.

28. The method of claim 27, wherein the transaction negative point is determined as the time point when the buying prediction line or the selling prediction line in the exit window begin to show opposite tendency greater than a predetermined threshold.

29. The system of claim 28, wherein an alert is issued when the transaction positive point is detected and the transaction negative point is not detected at a given moment.
